(19) United States
(12) Patent Application Publication
(10) Pub. No.: US 2018/0039626 A1
(43) Pub. Date: Feb. 8, 2018

(54) SYSTEM AND METHOD FOR TAGGING MULTIMEDIA CONTENT ELEMENTS BASED ON FACIAL REPRESENTATIONS

(71) Applicant: Cortica, Ltd., Tel Aviv (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/684,377

(22) Filed: Aug. 23, 2017

Related U.S. Application Data
(63) Continuation-in-part of application No. 15/206,792, filed on Jul. 11, 2016.
Application No. 15/206,792 is a continuation-in-part of application No. 14/509,558, filed on Oct. 8, 2014, now Pat. No. 9,575,969.
Application No. 14/509,558 is a continuation of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009, now Pat. No. 9,798,795.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009, now Pat. No. 9,798,795.
(60) Provisional application No. 62/378,222, filed on Aug. 23, 2016.
(60) Provisional application No. 62/289,187, filed on Jan. 30, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/3002; G06F 17/30109; G06F 17/301; Y10S 707/99948; Y10S 707/99943

(57) ABSTRACT

A system and method for tagging multimedia content based on facial representations. The method includes comparing signatures generated for a multimedia content element to signatures representing facial concepts of a plurality of facial representations, wherein each concept is a collection of signatures and metadata describing a facial feature; determining, based on the comparison, at least one matching facial representation for the multimedia content element; identifying, based on the determined at least one matching facial representation, at least one tag for the multimedia content element; and assigning the identified at least one tag to the multimedia content element.

### CROSS-REFERENCE TO RELATED APPLICATIONS

This application claims the benefit of U.S. Provisional Application No. 62/378,222 filed on Aug. 23, 2016, the contents of which are hereby incorporated by reference. This application is also a continuation-in-part (CIP) of U.S. patent application Ser. No. 15/206,792 filed on Jul. 11, 2016, now pending, which claims the benefit of U.S. Provisional Patent Application No. 62/289,187 filed on Jan. 30, 2016. The 15/206,792 application is also a CIP of U.S. patent application Ser. No. 14/509,558 filed on Oct. 8, 2014, now U.S. Pat. No. 9,575,969, which is a continuation of U.S. patent application Ser. No. 13/602,858 filed on Sep. 4, 2012, now U.S. Pat. No. 8,868,619. The 13/602,858 Application is a continuation of U.S. patent application Ser. No. 12/603,123 filed on Oct. 21, 2009, now U.S. Pat. No. 8,266,185. The 12/603,123 Application is a CIP of:
(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006;
(2) U.S. patent application Ser. No. 12/195,863, filed Aug. 21, 2008, now U.S. Pat. No. 8,326,775, which claims priority under 35 USC 119 from Israeli Application No. 185414 filed on Aug. 21, 2007, and which is also a CIP of the above-referenced U.S. patent application Ser. No. 12/084,150;
(3) U.S. patent application Ser. No. 12/348,888, filed on Jan. 5, 2009, now pending, which is a CIP of the above-referenced U.S. patent application Ser. Nos. 12/084,150 and 12/195,863; and
(4) U.S. patent application Ser. No. 12/538,495 filed on Aug. 10, 2009, now U.S. Pat. No. 8,312,031, which is a CIP of the above-referenced U.S. patent application Nos. 12/084,150, 12/195,863, and 12/348,888.

All of the applications referenced above are herein incorporated by reference for all that they contain.

### TECHNICAL FIELD

The present disclosure relates generally to analysis of multimedia content, and more specifically to tagging multimedia content elements showing faces.

### BACKGROUND

With the advent of social media and other user interaction environments, many entities now offer services allowing users to create customized user profiles. Such customized user profiles allow users to express their interests, personalities, and appearances. To this end, the customized user profiles often allow users to create facial or other image-based representations or avatars. Some image-based representations may be made based on user inputs (e.g., selections of body types, body parts, skin color, etc.), while other representations may be automatically created based on images of a user.

While some existing solutions allow for automatically tagging images and other multimedia content based on content therein, these solutions face challenges in accurately identifying faces of users, particularly when a user's face is obscured, captured at different angles, subject to different lighting conditions, different relative sizes within images, and the like. As such, the aforementioned image-based representations of existing solutions cannot be utilized to accurately tag images showing a user's face. Consequently, many automatically tagged images are tagged incorrectly, or may lack appropriate tags.

It would be therefore advantageous to provide a solution that overcomes the deficiencies of the existing solutions.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for tagging multimedia content based on facial representations. The method comprises comparing signatures generated for a multimedia content element to signatures representing facial concepts of a plurality of facial representations, wherein each concept is a collection of signatures and metadata describing a facial feature; determining, based on the comparison, at least one matching facial representation for the multimedia content element; identifying, based on the determined at least one matching facial representation, at least one tag for the multimedia content element; and assigning the identified at least one tag to the multimedia content element.

Certain embodiments disclosed herein also include a non-transitory computer readable medium having stored thereon causing a processing circuitry to execute a process for tagging multimedia content based on facial representations, the process comprising: comparing signatures generated for a multimedia content element to signatures representing facial concepts of a plurality of facial representations, wherein each concept is a collection of signatures and metadata describing a facial feature; determining, based on the comparison, at least one matching facial representation for the multimedia content element; identifying, based on the determined at least one matching facial representation, at least one tag for the multimedia content element; and assigning the identified at least one tag to the multimedia content element.

Certain embodiments disclosed herein also include a system for tagging multimedia content based on facial representations. The system comprises: a processing circuitry; and a memory, the memory containing instructions that, when executed by the processing circuitry, configure the system to: compare signatures generated for a multimedia content element to signatures representing facial concepts of a plurality of facial representations, wherein each concept is a collection of signatures and metadata describing a facial feature; determine, based on the comparison, at least one matching facial representation for the multimedia content element; identify, based on the determined at least one matching facial representation, at least one tag for the multimedia content element; and assign the identified at least one tag to the multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments disclosed herein.

FIG. 2 is a flowchart illustrating a method for generating a facial representation of a user according to an embodiment.

FIG. 3 is a flowchart illustrating a method for analyzing a plurality of multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a flowchart illustrating a method for determining a context based on multimedia content elements.

FIG. 7 is a block diagram of a tag generator according to an embodiment.

FIG. 8 is a flowchart illustrating a method for tagging multimedia content based on facial representations according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some features but not to others. In general, unless otherwise indicated, singular elements may be in plural and vice versa with no loss of generality. In the drawings, like numerals refer to like parts through several views.

The disclosed embodiments include a system and method for tagging multimedia content based on facial representations. Signatures are generated to a multimedia content element. Each of the signatures represents a concept, where a concept is a collection of signatures and metadata describing the concept. One or more matching facial representations is determined based on the generated signatures. Each facial representation is a cluster of concepts of facial features of a user shown in the multimedia content element. Metadata associated with each matching facial representation is assigned to the multimedia content element as a tag.

Utilizing signatures for identifying and tagging multimedia content elements showing faces allows for more accurate tagging than, for example, by matching multimedia content directly. Further, utilizing signatures robust to noise and distortion as described herein may allow for additional accuracy, particularly with respect to multimedia content captured under different circumstances, for example at different angles, featuring partial obstructions of faces, and the like.

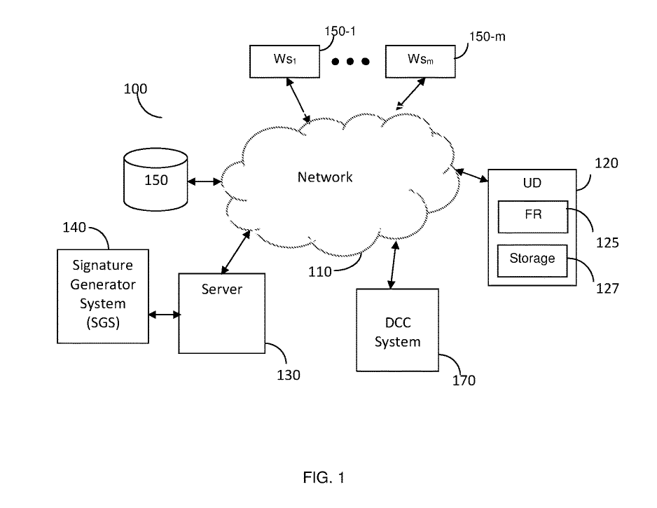

FIG. 1 shows an example network diagram 100 utilized to describe the various disclosed embodiments. A network 110 is used to communicate between different parts of the network diagram 100. The network 110 may be the Internet, the world-wide-web (WWW), a local area network (LAN), a wide area network (WAN), a metro area network (MAN), and other networks capable of enabling communication between elements of the network diagram 100.

Further communicatively connected to the network 110 is a user device (UD) 120. The user device 120 may be, but is not limited to, a personal computer (PC), a personal digital assistant (PDA), a mobile phone, a smart phone, a tablet computer, an electronic wearable device (e.g., glasses, a watch, etc.), a smart television, or any other wired or mobile device equipped with browsing, viewing, capturing, storing, listening, filtering, and managing capabilities enabled as further discussed herein below.

The user device 120 may further include a facial recognizer (FR) 125 installed thereon. The facial recognizer 125 may be a dedicated application, script, or any program code stored in a memory of the user device 120 and is executable, for example, by a processing system (e.g., microprocessor) of the user device 120. The facial recognizer 125 may be pre-installed in the user device 120. In a non-limiting embodiment, the facial recognizer 125 may be downloaded from an application repository (not shown) such as, for example, the AppStore®, Google Play®, or any repositories hosting software applications. The facial recognizer 125 may be configured to perform some or all of the processes performed by a server 130 and disclosed herein. Specifically, in an embodiment, the facial recognizer 125 may be configured to, e.g., generate facial representations, tag multimedia content elements, or both. In an embodiment, the user device 120 includes a local storage 127 for storing multimedia content elements, concepts, signatures of multimedia content elements, tags for multimedia content elements, or a combination thereof. It should be noted that only one user device 120 and one facial recognizer 125 are discussed with respect to FIG. 1 merely for the sake of simplicity and without limitation on the disclosure.

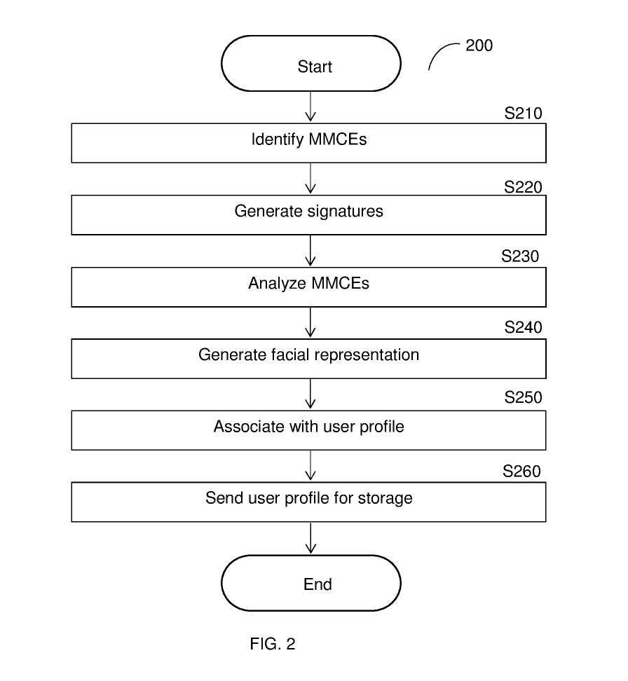

The data warehouse 150 may store facial representations associated with users (e.g., a user of the user device 120). The facial representations may be generated, for example, by the user device 120, by the server 130, or a combination thereof, as described further herein with respect to FIG. 2. In an example implementation, each facial representation includes a cluster of facial concepts of a user. Each signature represents a concept, where a concept is a collection of signatures and metadata describing the concepts. The facial representation may include signatures representing concepts of facial features of the user.

According to an embodiment, the data warehouse 150 may be associated with a social networking website or entity utilized by a user of the user device 120. According to another embodiment, the data warehouse 150 may be a cloud-based storage accessible by the user device 120. In the embodiment illustrated in FIG. 1, either or both of the user device 120 and the server 130 communicates with the data warehouse 150 through the network 110. Such communication may be subject to an approval to be received from the user device 120. In some implementations, the data warehouse 150 may further include multimedia content elements, for example images uploaded by the user of the user device 120 to a social media website.

In an embodiment, either or both of the user device 120 and the server 130 is further communicatively connected to a signature generator system (SGS) 140 and to a deep-content classification (DCC) system 170 directly or through the network 110. In another embodiment, each of the DCC system 170 and the SGS 140 may be embedded in the server 130 or in the user device 120. In a further embodiment, the SGS 140 may further include a plurality of computational cores configured for signature generation, where each computational core is at least partially statistically independent from the other computational cores. It should be noted that each of the user device 120 and the server 130 typically includes a processing circuitry (not shown) coupled to a memory (not shown). The memory contains instructions that can be executed by the processing circuitry.

According to an embodiment, upon receiving access to one or more storage units associated with the user of the user device 120, the server 130 is configured to identify one or more multimedia content elements stored therein to be tagged. The storage units may include the web sources 160, the local storage 127 of the user device 120, the data warehouse 150, or any other storage including multimedia content elements associated with a user of the user device 120. A multimedia content element may be, but is not limited to, an image, a graphic, a video stream, a video clip, an audio stream, an audio clip, a video frame, a photograph, an image of signals (e.g., spectrograms, phasograms, scalograms, etc.), a combination thereof, or a portion thereof. In an example implementation, the multimedia content elements to be tagged may include multimedia content elements lacking tags, multimedia content elements that were not previously tagged by the user device 120 or the server 130, and the like.

Alternatively, the server 130 may be configured to receive a multimedia content element to be tagged from the user device 120 accompanied by a request to tag the multimedia content element. With this aim, the server 130 sends the received multimedia content element to the SGS 140, to the DCC system 170, or to both. The decision which is used (e.g., by the SGS 140, the DCC system 170, or both) may be a default configuration or based on the request.

In an embodiment, the SGS 140 is configured to receive a multimedia content and to return at least one signature for the received multimedia content element. The generated signature(s) may be robust to noise and distortion. To this end, the SGS 140 may include a plurality of computational cores, where each computational core is at least partially statistically independent of the other computational cores. The process for generating the signatures is discussed in detail herein below. The SGS 140 may send the generated signature(s) to the server 130.

Each signature generated for a multimedia content element represents a concept of the multimedia content element. A concept is a collection of signatures representing elements of the unstructured data and metadata describing the concept. The concept may be a signature-reduced cluster of related signatures. As a non-limiting example, a ‘Superman concept’ is a signature-reduced cluster of signatures describing elements (e.g., multimedia elements) related to, e.g., a Superman cartoon: a set of metadata representing proving textual representation of the Superman concept. Techniques for generating concept structures are also described in the above-referenced U.S. Pat. No. 8,266,185, assigned to the common assignee, which is hereby incorporated by reference for all that it contains.

In an embodiment, based on the generated signature(s), the server 130 is configured to search in the data warehouse 150 for a matching facial representation for the multimedia content to be tagged. When the multimedia content element to be tagged shows a face of the user of the user device 120, the matching facial representation includes a cluster of facial concepts associated with the user of the user device 120. To this end, the facial representation includes signatures representing the facial concepts associated with the user and metadata indicating the user whose face is represented by the facial representation.

In an embodiment, the server 130 is configured to determine the matching facial representation by comparing the generated signature to signatures of the facial representations stored in the data warehouse 150. The signatures of the facial representations may include signatures representing the clustered facial concepts of the facial representations, and may be signature-reduced clusters representing each facial concept.

In an embodiment, based on the metadata of the matching facial representation, the server 130 is configured to assign a tag to the multimedia content element. The tag indicates the user whose face is shown in the multimedia content element. As a non-limiting example, if an image shows a face of a person John Smith, a matching facial representation for John Smith may be determined and the tag “John Smith” associated with the matching facial representation is assigned to the image.

In a further embodiment, the multimedia content element may be added to a cluster of multimedia content elements associated with the facial representation. The cluster of multimedia content elements may include multimedia content elements showing the user and, in particular, portions of the user's face. The cluster may further include multimedia content elements showing similar facial features, for example, facial features of family members or other persons having similar facial features. Facial features may be similar if signatures of their respective concepts match above a predetermined threshold.

It should be noted that multiple matching facial representations may be equally determined for the multimedia content element to be tagged without departing from the scope of the disclosure. Metadata of each matching facial representation may be utilized to generate a tag for the multimedia content element, thereby allowing for tagging each user whose face is shown in the multimedia content element. For example, an image showing faces of three people may be matched to three different facial representations, and three tags may be generated for the image.

In an example implementation, each facial representation may be created based on analysis of multimedia content elements related to a user. The analysis may include identification of the source in which each multimedia content element was identified, analysis of metadata of each multimedia content element, one or more matching concepts for each multimedia content element, a combination thereof, and the like.

The sources from which the multimedia content elements were identified may be relevant in determining whether each multimedia content element shows the user's face or facial features. The metadata may be relevant in determining whether environmental parameters (e.g., sunlight or lack thereof) which may affect the appearance of faces in multimedia content elements are present, whether the multimedia content element is tagged with an indication of the content therein (e.g., a tag of “selfies” may indicate that the multimedia content element shows a face), and the like.

The matching concepts of the multimedia content element may be identified by sending a query to the DCC system 170 to match the received multimedia content element to at least one concept. The identification of a concept matching the received multimedia content element includes matching at least one signature generated for the received multimedia content element (e.g., signatures generated either by the SGS 140 or by the DCC system 170) and comparing the element's signatures to signatures representing a concept structure. The matching can be performed across all concept structures maintained by the system DCC 170.

It should be noted that, if the query sent to the DCC system 170 results in matching multiple concept structures, a correlation for matching concept structures is performed to generate a facial representation of a user that best describes the user's face. The correlation can be achieved by identifying a ratio between signatures' sizes, a spatial location of each signature, using probabilistic models, or a combination thereof.

In an example implementation, the facial representation includes the signatures representing facial concepts, thereby allowing for matching the facial representation to multimedia content elements based on signature matching. The facial concepts include concept structures related to facial features such as, but not limited to, eyes, hair, mouth, nose, eyebrows, forehead, ears, cheeks, forehead, facial hair, and the like.

The facial representation may be generated based on multimedia content elements that are determined as optimally describing the face of the user. For example, the optimally descriptive multimedia content elements may include images of, but not limited to, a nose, hair, eyes, a mouth, facial hair, eyebrows, a forehead, cheeks, a chin, birth marks, and the like. The generated facial representation may be sent for storage in, for example, the data warehouse 150.

To this end, generating the facial representation may include analyzing the multimedia content elements featuring the face of the user and determining, based on the analysis, the optimally descriptive multimedia content elements. In a further embodiment, the analysis may be based on the analysis of the signatures of the multimedia content elements featuring the face of the user.

Each facial representation is associated with a tag indicating a user. In an example implementation, the associated tag may be identified from among metadata associated with multimedia content elements based on which the facial representation was generated. For example, if metadata of each multimedia content elements showing facial features includes the name “John Smith,” a tag “John Smith” is identified and associated with the facial representation.

Example techniques for generating facial representations based on multimedia content elements are described further herein below with respect to FIG. 2 and in the above-noted U.S. patent application Ser. No. 15/206,792, assigned to the common assignee, the contents of which are hereby incorporated by reference.

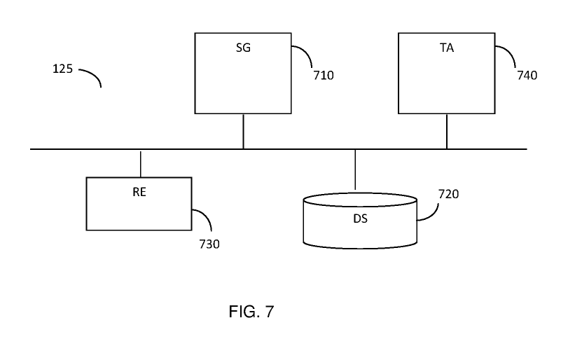

It should be noted that certain tasks performed by the server 130, the SGS 140, and the DCC system 170 may be carried out, alternatively or collectively, by the user device 120 and the facial recognizer 125. Specifically, in an embodiment, signatures may be generated by a signature generator (e.g., the signature generator 710 discussed further herein below with respect to FIG. 7). An example block diagram of a facial recognizer 125 installed on a user device 120 is described further herein below with respect to FIG. 7.

It should also be noted that the signatures may be generated for multimedia content elements stored in the data sources 150, in the local storage 127 of the user device 120, or in a combination thereof.

FIG. 2 depicts an example flowchart 200 illustrating a method for generating a facial representation according to an embodiment. In an embodiment, the method may be performed by a server (e.g., the server 130). In another embodiment, the method may be performed by a facial recognizer (e.g., the facial recognizer 125 installed on the user device 120).

At S210, multimedia content elements are identified through data sources associated with a user of a user device. The multimedia content elements may be identified based on a request for creating a user profile. The request may indicate, for example, particular multimedia content elements to be identified, data sources in which the multimedia content elements may be identified, metadata tags of multimedia content elements to be identified, combinations thereof, and the like. The data sources may include, but are not limited to, web sources (e.g., the web sources 160), a local storage (e.g., the local storage 127 of the user device 120 or a local storage associated with the server 130), a combination thereof, and the like.

In a further embodiment, S210 may include pre-filtering multimedia content elements that are unrelated to the user's face or to faces generally. To this end, S210 may further include analyzing metadata tags associated with multimedia content elements in the data sources to identify multimedia content elements featuring the user's face. As a non-limiting example, if tags associated with a multimedia content element indicate that the multimedia content element does not show a person or, in particular, does not show the user, the multimedia content element may be pre-filtered out. The pre-filtering may reduce subsequent usage of computational resources due to, e.g., signature generation, concept correlation, and the like.

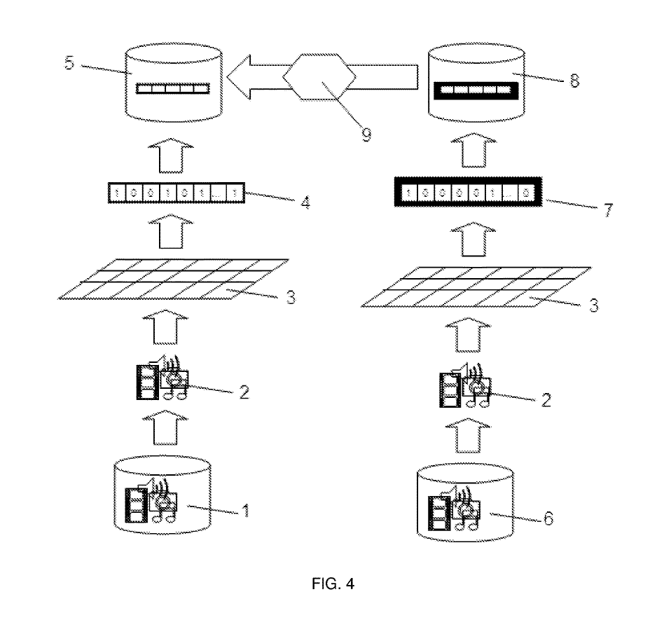

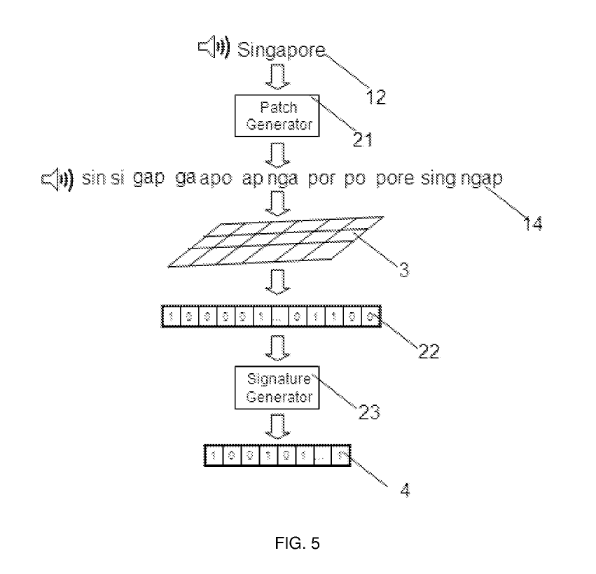

At S220, at least one signature is generated for each identified multimedia content element. In an embodiment, S220 may include generating a signature for portions of any or all of the multimedia content elements. Each signature represents a concept associated with the multimedia content element. For example, a signature generated for a multimedia content element featuring a man in a costume may represent at least a “Batman®” concept. The signature(s) are generated by a signature generator (e.g., the SGS 140 or the signature generator 710) as described herein below with respect to FIGS. 4 and 5.

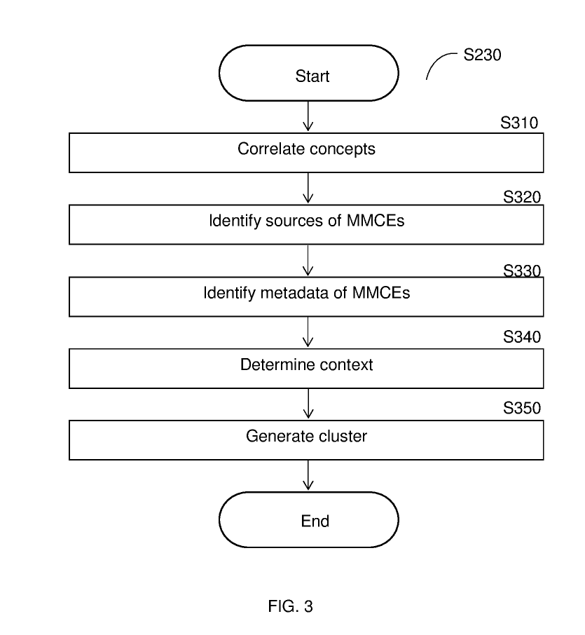

At S230, the identified multimedia content elements are analyzed based on the signatures. In an embodiment, the analysis includes determining a context of the identified multimedia content elements related to the user's face. In a further embodiment, the analysis includes determining, based on the context, multimedia content elements that optimally describe the user's face and generating a cluster including signatures representing the optimally descriptive multimedia content elements. Determining contexts of multimedia content elements based on signatures is described further herein below with respect to FIG. 3.

At S240, based on the analysis of the multimedia content elements, a facial representation of the user of the user device is generated. In an embodiment, generating the facial representation may include generating a cluster of signatures including signatures associated with multimedia content elements that optimally describe the face of the user as described further herein above with respect to FIG. 1.

In another embodiment, generating the facial representation may include filtering out multimedia content elements or portions thereof that are not related to the user's face. In yet another embodiment, generating the facial representation may include determining, based on the optimally descriptive multimedia content elements, a list of facial features. The list of facial features may include a plurality of textual multimedia content elements associated with any of the optimally descriptive multimedia content elements.

At S250, the facial representation is associated with a user profile of the user of the user device. In an embodiment, S250 includes creating a user profile and associating the facial representation with the generated user profile. In a further embodiment, creating the user profile may include analyzing a plurality of multimedia content elements associated with the user to determine information related to the user such as, for example, interests of the user, contacts of the user (e.g., friends, family, and acquaintances), events the user has attended, a profession of the user, and the like. An example method and system for creating user profiles based on analysis of multimedia content elements is described further in U.S. patent application Ser. No. 15/206,711, assigned to the common assignee, which is hereby incorporated by reference.

At S260, the generated user profile is sent for storage in a storage such as, for example, the data warehouse 150.

FIG. 3 depicts an example flowchart S230 illustrating a method for analyzing a plurality of multimedia content elements and determining contexts of the multimedia content elements according to an embodiment. In an embodiment, the method is performed using signatures generated for the multimedia content elements by a signature generator system.

At S310, at least one concept structure matching the multimedia content elements is identified. In an embodiment, the concept structure is identified based on the signatures of the multimedia content elements. In a further embodiment, S310 may include querying a DCC system (e.g., the DCC system 170) using the signatures generated for the multimedia content elements. The metadata of the matching concept structure is used for correlation between a first multimedia content element and at least a second multimedia content element of the plurality of multimedia content elements.

At optional S320, a source of each multimedia content element is identified. As further described hereinabove, the source of each multimedia content element may be indicative of the content or the context of the multimedia content element. In an embodiment, S320 may further include determining, based on the source of each multimedia content element, at least one potential context of the multimedia content element. In a further embodiment, each source may be associated with a plurality of potential contexts of multimedia content elements. As a non-limiting example, for a multimedia content stored in a source including video clips of basketball games, potential contexts may include, but are not limited to, “basketball,” “the Chicago Bulls®,” “the Golden State Warriors®,” “the Cleveland Cavaliers®,” “NBA,” “WNBA,” “March Madness,” and the like.

At optional S330, metadata associated with each multimedia content element is identified. The metadata may include, for example, a time pointer associated with the capture or upload of each multimedia content element, a location pointer associated the capture or upload of each multimedia content element, one or more tags added to each multimedia content element, a combination thereof, and so on.

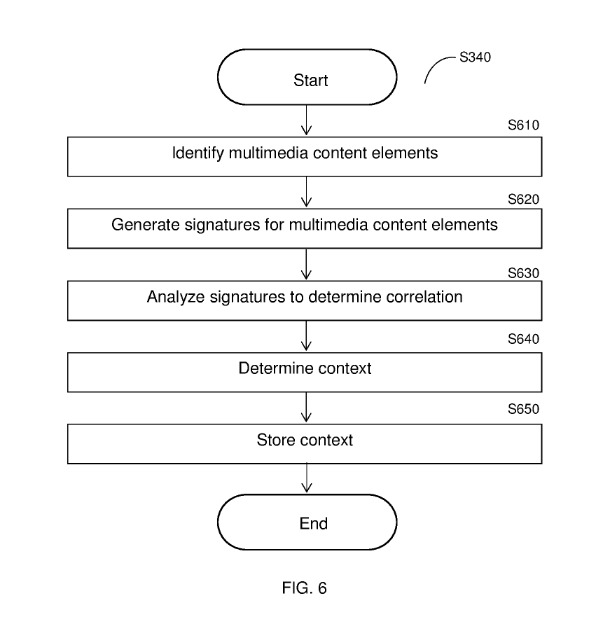

At S340, a context of the multimedia content elements is determined. In an embodiment, the context may be determined based on the correlation between a plurality of concepts related to multimedia content elements. The context may be further based on relationships between the multimedia content elements. Determining contexts of multimedia content elements based on concepts is described further herein below with respect to FIG. 6.

At S350, based on the determined context, a cluster including signatures related to multimedia content elements that optimally describe the user's face is generated. In an embodiment, S350 includes matching the generated signatures to a signature representing the determined context. Signatures matching the context signature above a predefined threshold may be determined to represent multimedia content elements that optimally describe the user's face. In a further embodiment, the cluster may be a signature reduced cluster.

FIGS. 4 and 5 illustrate the generation of signatures for the multimedia content elements by the SGS 140 according to one embodiment. An example high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An example process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the server 130, the user device 120, or both, is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

VᵢΣⱼwᵢⱼkⱼ

nᵢ=θ(Vi−Thₓ)

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one of the following criteria:
1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:
(a) The Cores should be designed so as to obtain maximal independence, i.e., the projection from a signal space should generate a maximal pair-wise distance between any two cores' projections into a high-dimensional space.
(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The Cores should be optimally designed with regard to invariance to a set of signal distortions, of interest in relevant applications.

A detailed description of the Computational Core generation and the process for configuring such cores is discussed in more detail in the above-noted U.S. Pat. No. 8,655,801, the contents of which are hereby incorporated by reference.

FIG. 6 is an example flowchart S340 illustrating a method for determining a context of a plurality of multimedia content elements based on concepts according to an embodiment.

At S610, a plurality of multimedia content elements is identified. The identified multimedia content elements may be received from, e.g., a user device, or retrieved from, e.g., a data warehouse.

At S620, at least one signature is identified for each of the multimedia content elements. In an embodiment, each signature may be generated as described further herein above with respect to FIGS. 4 and 5. It should also be noted that any of the signatures may be generated based on a portion of a multimedia content element.

At S630, the generated signatures are analyzed to determine a correlation between the signatures of the multimedia content elements or portions thereof. In an embodiment, S630 includes determining correlations between concepts of the multimedia content elements. In a further embodiment, the correlations between concepts are determined by identifying a ratio between signatures' sizes, a spatial location of each signature, and so on using probabilistic models. Each signature represents a concept and is generated for a multimedia content element. Thus, identifying, for example, the ratio of signatures' sizes may also indicate the ratio between the size of their respective multimedia elements.

At S640, based on the analysis of the generated signatures, a context of the plurality of multimedia content elements is determined. In an embodiment, it may further be determined whether the context is a strong context.

A context is determined as the correlation between a plurality of concepts. A strong context is determined when there are multiple concepts, i.e., a plurality of concepts that satisfy the same predefined condition. As an example, signatures generated for multimedia content elements of a smiling child with a Ferris wheel in the background are analyzed. The concept of the signature of the smiling child is “amusement” and the concept of a signature of the Ferris wheel is “amusement park”. The relationship between the signatures of the child and of the Ferris wheel may be further analyzed to determine that the Ferris wheel is bigger than the child. The relation analysis results in a determination that the Ferris wheel is used to entertain the child. Therefore, the determined context may be “amusement.”

According to an embodiment, one or more typically probabilistic models may be utilized to determine the correlation between signatures representing concepts. The probabilistic models determine, for example, the probability that a signature may appear in the same orientation and in the same ratio as another signature. The analysis may be further based on previously analyzed signatures.

In another embodiment, the context can be determined further based on a ratio of the sizes of the objects in the multimedia content elements and their relative spatial orientations (i.e., position, arrangement, direction, combinations thereof, and the like). For example, based on an image containing multimedia content elements related to bears having different sizes, a context may be determined as “family of bears.” As another example, based on an image containing multimedia content elements of people facing the same direction (toward a camera) and having similar sizes as well as a banner for a school saying “graduation,” a context may be determined as “graduation photograph.”

At S650, the determined context is stored in, e.g., the data warehouse 150.

As a non-limiting example, a plurality of multimedia content elements contained in an image is identified. According to this example, multimedia content elements of the singer “Adele”, “red carpet”, and a “Grammy” award are shown in the image. Signatures are generated for each of the multimedia content elements. The correlation between “Adele”, “red carpet”, and a “Grammy” award is determined with respect to the signatures and the context of the image is determined based on the correlation. According to this example, such a context may be “Adele Winning the Grammy Award”. The determined context is stored in a data warehouse.

As another non-limiting example, multimedia content elements related to objects such as a “glass”, a “cutlery”, and a “plate” are identified. Signatures are generated for the glass, cutlery, and plate multimedia content elements. The correlation between the concepts represented by the signatures is determined based on previously analyzed signatures of glasses, cutlery, and plates. According to this example, as all of the concepts related to the “glass”, the “cutlery”, and the “plate” satisfy the same predefined condition, a strong context is determined. Based on the correlation among the multimedia content elements and the relative sizes and orientations of the objects illustrated by the multimedia content elements, the context of such concepts is determined to be a “table set”.

FIG. 7 depicts an example block diagram of a facial recognizer 125 installed on the user device 120 according to an embodiment. The facial recognizer 125 may be configured to access an interface of the user device 120 or of a server. The facial recognizer 125 is further communicatively connected to a processing system (PS, not shown) such as a processor and to a memory (mem). The memory contains therein instructions that, when executed by the processing system, configures the facial recognizer 125 as further described hereinabove and below. The facial recognizer 125 may further be communicatively connected to a storage unit (e.g., the local storage 127 of the user device 120, the data warehouse 150, or a storage of the server 130) including a plurality of multimedia content elements.

In an embodiment, the facial recognizer 125 includes a signature generator (SG) 710, a data storage (DS) 720, a recommendations engine 730, and a tag assigner (TA) 740. The signature generator 710 may be configured to generate signatures for multimedia content elements. In a further embodiment, the signature generator 710 includes a plurality of computational cores as discussed further herein above, where each computational core is at least partially statistically independent of the other computations cores.

The data storage 720 may store a plurality of multimedia content elements, a plurality of concepts, signatures for the multimedia content elements, signatures for the concepts, or a combination thereof. In a further embodiment, the data storage 720 may include a limited set of concepts relative to a larger set of known concepts. Such a limited set of concepts may be utilized when, for example, the data storage 720 is included in a device having a relatively low storage capacity such as, e.g., a smartphone or other mobile device.

The recommendations engine 730 may be configured to generate contextual insights based on multimedia content elements related to the user interest, to query sources of information (including, e.g., the data storage 720 or another data source), and to cause a display of recommendations on the user device 120.

According to an embodiment, the facial recognizer 125 is configured to receive at least one multimedia content element. The facial recognizer 125 is configured to initialize a signatures generator (SG) 710 to generate at least one signature for the received at least one multimedia content element.

In an embodiment, the facial recognizer 125 is configured to initialize the tag assigner 740 to match a facial representation to a multimedia content element to be tagged. The facial representation may be generated based on signatures generated for the received at least one multimedia content element. The facial representation includes may include a plurality or cluster of signatures associated with the optimally descriptive multimedia content elements, and has metadata describing a user. The tag assigner 740 is configured to compare signatures of the multimedia content element to be tagged to signatures of one or more facial representations to determine one or more matching facial representations. Based on metadata of the matching facial representations, the tag assigner 740 is configured to assign one or more tags to the multimedia content element.

Each of the recommendations engine 730 and the signature generator 710 can be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In certain implementations, the recommendation engine 730, the signature generator 710, or both can be implemented using an array of computational cores having properties that are at least partly statistically independent from other cores of the plurality of computational cores. The computational cores are further discussed below.

According to another implementation, the processes performed by the recommendation engine 730, the signature generator 710, or both can be executed by a processing system of the user device 120 or server 130. Such processing system may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that, although FIG. 7 is described with respect to a facial recognizer 125 included in the user device 120, any or all of the components of the facial recognizer 125 may be included in another system or systems (e.g., the server 130, the signature generator system 140, or both) and utilized to perform some or all of the tasks described herein without departing from the scope of the disclosure.

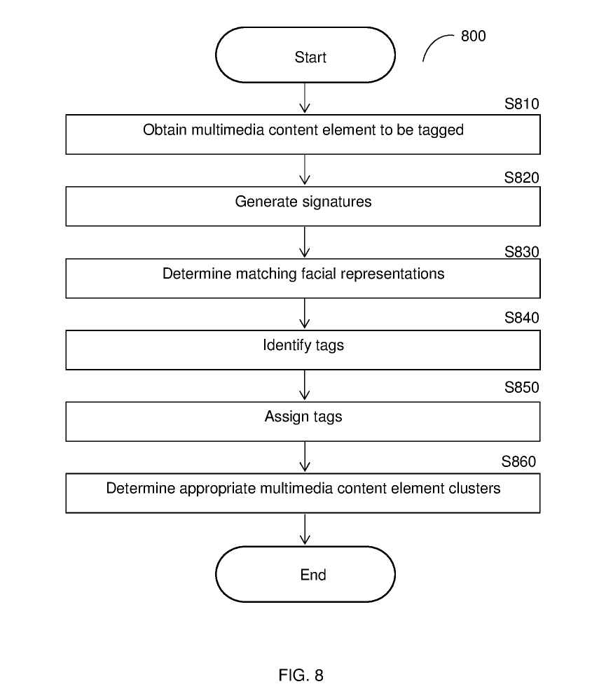

FIG. 8 is an example flowchart 800 illustrating a method for tagging multimedia content based on facial representations according to an embodiment. In an embodiment, the method may be performed by the facial recognizer 125 or the server 130.

At S810, a multimedia content element to be tagged is obtained. The multimedia content element to be tagged may be received, or may be retrieved from a data source. The data source may be, for example, a storage unit storing multimedia content elements of, for example, social media websites.

At S820, signatures are generated for the obtained multimedia content element. Each signature represents a concept, which is a collection of signatures and metadata describing the concept. In an example implementation, the signatures may be generated as described herein above. To this end, in an embodiment, S820 may include sending the multimedia content element to a signature generator system and receiving, from the signature generator system, signatures generated for the multimedia content element.

At S830, one or more matching facial representations is determined for the multimedia content element based on the signatures. Each facial representation includes a cluster of facial concepts demonstrating facial features of a user. In an embodiment, S830 includes comparing the signatures of the multimedia content element to signatures representing facial concepts of facial representations. Each matching facial representation has facial concept signatures matching the signatures of the multimedia content element above a predetermined threshold. The facial concept signatures may include the signatures of each concept, a signature reduced cluster of the signatures of the concept, and the like.

At S840, based on the determined facial representations, one or more tags to be assigned to the multimedia content element is identified. The identified tags may be associated with the determined facial representations in, for example, a data warehouse. Each facial representation is associated with a tag indicating a user such that the identified tags indicate users shown in the multimedia content element.

At S850, the identified tags are assigned to the multimedia content element. In an embodiment, S850 includes storing the identified tags as metadata for the multimedia content element.

At optional S860, based on the assigned tags, one or more appropriate clusters of multimedia content elements to which the multimedia content element should be added may be determined. The appropriate clusters may be clusters associated with the tags. For example, a tag indicating a user “John Smith” may be added to a cluster of multimedia content elements showing members of the Smith family. The multimedia content element may be added to each determined multimedia content element cluster.

It should be noted that various embodiments described herein above are discussed with respect to a user and, in particular, a user of a user device, merely for simplicity purposes and without limitation on the disclosed embodiments. The embodiments described herein are equally applicable to any entity (e.g., humans, animals, toys, etc.) having distinguishing facial characteristics that may be illustrated by multimedia content elements regardless of whether such entity is the owner or otherwise a user of a user device. For example, a facial representation may be generated for a dog whose ears, mouth, nose, fur, and eyes are shown in one or more pictures or videos.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for tagging multimedia content, comprising:
comparing signatures generated for a multimedia content element to signatures representing facial concepts of a plurality of facial representations, wherein each concept is a collection of signatures and metadata describing a facial feature;
determining, based on the comparison, at least one matching facial representation for the multimedia content element;
identifying, based on the determined at least one matching facial representation, at least one tag for the multimedia content element; and
assigning the identified at least one tag to the multimedia content element.

2. The method of claim 1, wherein each signature represents a concept.

3. The method of claim 1, wherein assigning the identified at least one tag to the multimedia content element further comprises:
storing the at least one tag as metadata associated with the multimedia content element.

4. The method of claim 1, wherein each identified tag is associated with one of the at least one matching facial representation in a storage.

5. The method of claim 1, further comprising:
generating each of the plurality of facial representations.

6. The method of claim 5, wherein generating each facial representation further comprises:
identifying, via at least one data source, at least one potential facial representation multimedia content element;
generating at least one signature for at least a portion of each identified potential facial representation multimedia content element, wherein each generated signature represents a facial concept of one of the at least one potential facial representation multimedia content element;
analyzing the generated signatures to determine a cluster of signatures of facial concepts; and
generating, based on the determined cluster of facial concept signatures, the facial representation.

7. The method of claim 5, wherein each facial representation is generated based on a source of each potential facial representation multimedia content element.

8. The method of claim 5, wherein each facial representation is generated based on metadata associated with each potential facial representation multimedia content element.

9. The method of claim 1, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, the properties are set independently of each other core.

10. A non-transitory computer readable medium having stored thereon instructions for causing a processing circuitry to perform a process for tagging multimedia content, the process comprising:
comparing signatures generated for a multimedia content element to signatures representing facial concepts of a plurality of facial representations, wherein each concept is a collection of signatures and metadata describing a facial feature;
determining, based on the comparison, at least one matching facial representation for the multimedia content element;
identifying, based on the determined at least one matching facial representation, at least one tag for the multimedia content element; and
assigning the identified at least one tag to the multimedia content element.

11. A system for tagging multimedia content, comprising:
a processing circuitry; and
a memory, wherein the memory contains instructions that, when executed by the processing circuitry, configure the system to:
compare signatures generated for a multimedia content element to signatures representing facial concepts of a plurality of facial representations, wherein each concept is a collection of signatures and metadata describing a facial feature;
determine, based on the comparison, at least one matching facial representation for the multimedia content element;
identify, based on the determined at least one matching facial representation, at least one tag for the multimedia content element; and
assign the identified at least one tag to the multimedia content element.

12. The system of claim 11, wherein each signature represents a concept.

13. The system of claim 11, wherein the system is further configured to:
store the at least one tag as metadata associated with the multimedia content element.

14. The system of claim 11, wherein each identified tag is associated with one of the at least one matching facial representation in a storage.

15. The system of claim 11, wherein the system is further configured to:
generate each of the plurality of facial representations.

16. The system of claim 15, wherein the system is further configured to, for each of the plurality of facial representations:
identify, via at least one data source, at least one potential facial representation multimedia content element;
generate at least one signature for at least a portion of each identified potential facial representation multimedia content element, wherein each generated signature represents a facial concept of one of the at least one potential facial representation multimedia content element;
analyze the generated signatures to determine a cluster of signatures of facial concepts; and
generate, based on the determined cluster of facial concept signatures, the facial representation.

17. The system of claim 15, wherein each facial representation is generated based on a source of each potential facial representation multimedia content element.

18. The system of claim 15, wherein each facial representation is generated based on metadata associated with each potential facial representation multimedia content element.

19. The system of claim 11, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, the properties are set independently of each other core.
